(19) United States
(12) Patent Application Publication
(10) Pub. No.: US 2023/0370179 A1
(43) Pub. Date: Nov. 16, 2023

(54) MEASUREMENT ACCURACY MONITORING

(71) Applicant: Nokia Solutions and Networks Oy, Espoo (FI)

(72) Inventors: Ingo VIERING, Munich, DE (US); Daniela LASELVA, Aalborg (DK); Sari Kaarina NIELSEN, Espoo (FI); Subramanya CHANDRASHEKAR, Bangalore (IN)

(21) Appl. No.: 18/249,042

(22) PCT Filed: Jul. 16, 2021
(86) PCT No.: PCT/EP2021/069919

§ 371 Date: Apr. 13, 2023

(30) Foreign Application Priority Data
Oct. 15, 2020 (FI) 20206019

(51) Int. Cl. H04B 17/309; H04B 7/06; H04B 17/10

(52) U.S. Cl. CPC H04B 17/309; H04B 7/0695; H04B 17/101

(57) ABSTRACT

Apparatus and method in a communication system are disclosed. One or more measurement reports are received (400) from a terminal device. One or more reference signals are received and measured (402) from the terminal device. The accuracy of the one or more received measurement reports is determined (404) based on comparison of the measurement reports and measured the reference signals and/or statistical analysis of the measurement reports.

### FIELD

The exemplary and non-limiting embodiments of the invention relate generally to wireless communication systems. Embodiments of the invention relate especially to apparatuses and methods in wireless communication networks.

### BACKGROUND

The use of wireless communication systems is constantly increasing in many application areas. Communication that was previously realised with wired connections is replaced by wireless connections as the wireless communication systems offer many advantages over wired systems.

The reliability of the wireless solutions is under constant development. Many features of wireless communication systems rely on measurements performed by the devices of the system. Monitoring the accuracy of the measurements improves the reliability and robustness of the system.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus of claim 1.

According to an aspect of the present invention, there is provided a method of claim 10.

According to an aspect of the present invention, there is provided a computer program comprising instructions of claim 16.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the invention.

### LIST OF DRAWINGS

Embodiments of the present invention are described below, by way of example only, with reference to the accompanying drawings, in which

FIGS. 1 and 2 illustrate examples of simplified system architecture of a communication system;

FIG. 3 illustrates an example of antenna/array beams;

FIGS. 4A and 4B are flowcharts illustrating some embodiments;

FIG. 5 is a signalling chart illustrating some embodiments and

FIG. 6 illustrate a simplified example of an apparatus applying some embodiments of the invention.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features, structures, units, modules etc. that have not been specifically mentioned.

Some embodiments of the present invention are applicable to a user terminal, a communication device, a base station, eNodeB, gNodeB, a distributed realisation of a base station, a network element of a communication system, a corresponding component, and/or to any communication system or any combination of different communication systems that support required functionality.

The protocols used, the specifications of communication systems, servers and user equipment, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. 3GPP (3rd Generation Partnership Project) is an organization that is co-ordinating the development of many wireless communication systems such as 5G or NR.

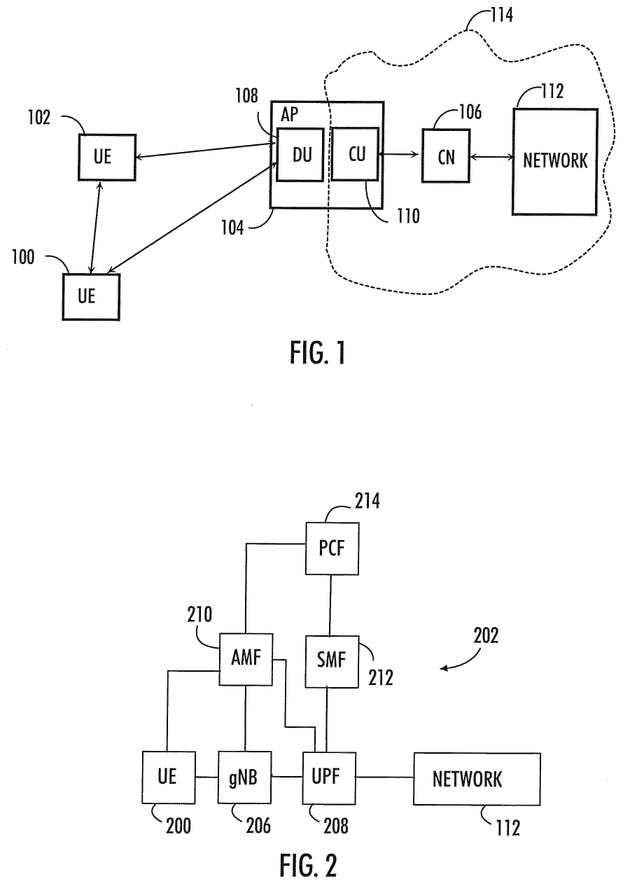

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one ore more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture, also denoted RAN split architecture in the 5G NG-RAN, enables RAN real time functions being carried out (in a distributed unit, DU 108) at or close to a remote antenna site hosting multiple transmission and reception points, TRPs, and/or Remote Radio heads, RRH, and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a (e/g)NodeB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

FIG. 2 illustrates an example of a communication system based on 5G network components. A user terminal or user equipment 200 communicating via a 5G network 202 with a data network 112. The user terminal 200 is connected to a Radio Access Network RAN node, such as (e/g)NodeB 206 which provides the user terminal with a connection to the network 112 via one or more User Plane Functions, UPF 208. The user terminal 200 is further connected to Core Access and Mobility Management Function, AMF 210, which is a control plane core connector for (radio) access network and can be seen from this perspective as the 5G version of Mobility Management Entity, MME, in LTE. The 5G network further comprises Session Management Function, SMF 212, which is responsible for subscriber sessions, such as session establishment, modify and release, and a Policy Control Function, PCF 214 which is configured to govern network behavior by providing policy rules to control plane functions.

It may be further noted that for 5G or NR, there has currently been defined two separated frequency ranges for use. The first frequency range, denoted as Frequency Range 1 (FR1), comprises frequency bands below 6 GHz. The other frequency range, denoted as is Frequency Range 2 (FR2), comprises frequency bands from 24.25 GHz to 52.6 GHz. Operations in frequency bands higher than FR2 can be expected in the future.

In 5G systems operating on FR2, both the (e/g)NodeB and terminal devices are expected to operate using antenna beams or radiation patterns narrower than sector-wide beams typically used in as in LTE based systems. Likewise, it is expected that the terminal devices operate using radiation patterns narrower than omni-directional beams. The reasons for the beam-based operations depend on the need for an increased array/antenna gain to compensate the higher path loss at mmWaves, but also due to technological limitations. For instance, the achievable power amplifier, PA, output power decreases as a function of the carrier frequency for any PA technology class. Further, when going to higher carrier frequencies more and more of the effective isotropic radiated power, EIRP, may be provided with an increased antenna/array gain. The increased antenna/array gain be achieved by narrowing the radiation patterns of antennas or antenna arrays, i.e. using narrow beams/directions. However, beam-based operation requires a good beam correspondence between the (e/g)NodeB and terminal devices, which is challenging to maintain since it is rather sensitive to blockages and beam misalignment between (e/g)NodeB and a terminal device that for instance is present due to mobility and rotation effects of the terminal device.

In an embodiment, the reception/transmission, Rx/Tx, beam alignment procedure between the (e/g)NodeB and the terminal device may be described using the following steps (which can be mapped to so-called phases P1-P3):
1. The (e/g)NodeB transmits probe signals in different directions using different Tx beams e.g. using synchronisation signal block, SSB, beams (P-1 and P-2).
2. The terminal device provides feedback on the best (e/g)NodeB Tx beam(s) (corresponding to a terminal device Rx beam(s)) (P-1 and P-2).
3. The (e/g)NodeB transmits potentially a signal in a repeated manner on the selected beam based on which the terminal device may refine its Rx beam (P-3).

In an embodiment, uplink, UL, beam management may be based on above steps, i.e. based on downlink reference signal(s) the terminal device's Tx beam(s) is/are determined. Another option is to determine UL Tx beam(s) based on Sounding Reference Signal, SRS, transmissions in a following manner:
1. The terminal device transmits probe signals in different directions using different Tx beam configurations.
2. The (e/g)NodeB provides feedback on the best terminal device Tx beam (corresponding to a (e/g)NodeB Rx beam).

It may be noted that phases P-2 and P-3 may require dedicated reference signals, such as Channel status information-reference signals, CSI-RS. The (e/g)NodeB may keep track of the Rx beam used to receive the transmission of a given terminal device according with the P-2 procedure which in turn is supported by the beam measurements taking place while the terminal device is in RRC CONNECTED state. This procedure is network controlled (i.e. the network can send a beam change command via Medium Access Control Control Element, MAC CE) and terminal device assisted (i.e. the terminal device reports periodically the Reference Signal Received Power on Layer 1, L1-RSRP, of the N best beams to aid beam selection at the network). Whenever the beam tracking fails, the terminal device triggers the beam failure detection and recovery procedure, which similarly to the beam tracking procedures is only applicable to terminal devices in RRC CONNECTED state.

Moreover, a terminal device is expected to have multiple antenna panels (antenna modules), disposed at different locations within the terminal device, when operating at FR2 or at higher frequencies in order to compensate for the additional path loss as compared to FR1. Different use possibilities of the antenna panels, such as whether one or multiple panels may be active at the same time, are under development.

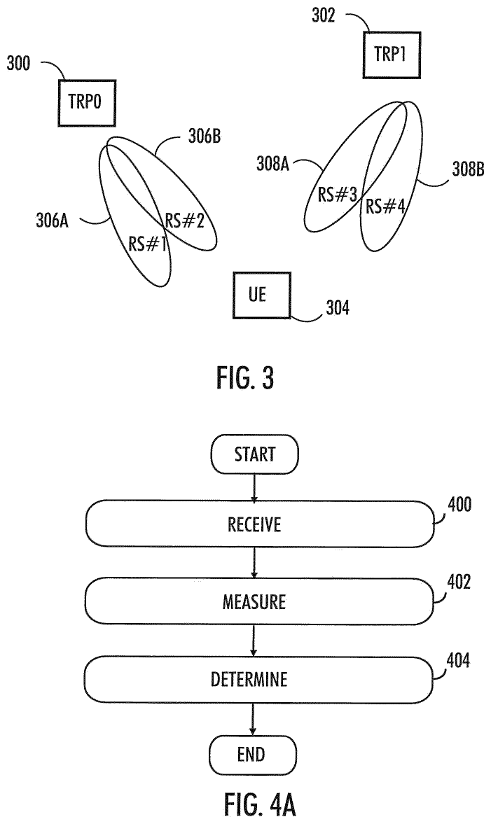

FIG. 3 illustrates the use of antenna/array beams. In the figure there are two (e/g)NodeBs, remote radio heads or a transmission reception points TRP0 300 and TRP1 302 and a terminal device 304. The (e/g)NodeB 300 transmits two beams 306A, 306B with Channel State Information-Reference Signals CSI-RS #1 and CSI-RS #1. The (e/g)NodeB 302 transmits two beams 308A, 308B with Channel State Information-Reference Signals CSI-RS #3 and CSI-RS #4.

The terminal devices are configured to measure signals transmitted by the (e/g)NodeB. Typical measurement is measurement of Reference Signal Received Power, RSRP. A terminal device in a RRC CONNECTED state measures RSRP and reports its measured RSRP levels and RSRP-based measurement events. The network is configured to use these measurement result in various operations controlling the connection of the terminal device, such as for mobility purposes. For example, these RSRP measurements are used by the network for various cell-level and beam-level mobility, including beam management.

RSRP accuracy requirements are defined by 3GPP for RRC CONNECTED terminal devices in both LTE and 5G systems. Table 1 illustrates requirements for Intra-frequency Synchronization Signal-based reference signal received power (SS-RSRP) requirements (left) and SSB/CSI-RS based L1-RSRP requirements (right) under normal conditions.

TABLE 1

| SS-RSRP | FR1 | FR2 | L1-RSRP | FR1 | FR2 |
|---|---|---|---|---|---|
| Absolute | ±4.5 dB | ±6 dB | Absolute | ±5 dB | ±6.5 dB |
| accuracy | | | accuracy | | |
| Relative | ±2 dB | ±6 dB | Relative | ±3 dB | ±6.5 dB |
| accuracy | | | accuracy | | |

The values for FR1 are inherited from LTE based system. For various reasons, the values for FR2 are significantly relaxed compared to the FR1 values. The requirements defined in NR for FR2 are pretty relaxed (up to ±6.5 dB is allowed), meaning that an RSRP variation up to 13 dB may be seen due to poor accuracy. It should be noted that loose requirements are defined in respect to both L3 measurements that control cell-level mobility (see the left table) as well as L1 measurements that control beam-level mobility and short-term beam selection (see the right table).

In general, the network-controlled mobility of terminal devices is based on RSRP reporting of the terminal devices. This applies to terminal devices in RRC_CONNECTED and may be categorized into two types of mobility: cell level mobility and beam level mobility. In both cases, the terminal device is configured by the network to transmits either periodic beam-level L1-RSRP reporting on PUCCH or measurement events reporting such as A3, which are typically based on RSRP.

Examples of measurement reporting triggering events for the NR intra-RAT case are shown below. These can be configured by the network with ReportConfigNR information element.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell.
Event I1: Interference

For event I1, measurement reporting event is based on Cross Link Interference, CLI, measurement results, which can either be derived based on SRS-RSRP or Channel status information-reference signal, CLI-RSSI.

Above, PCell denotes a Primary Cell and PSCell denotes a Primary Secondary Cell.

In general, a diverse UE behaviour may be expected from the first generations of 5G NR FR2 terminal devices, where the requirements will set the lower bound of the performance: some terminal devices may be able to achieve a better accuracy level than the requirements, especially in respect to the relative measurement accuracy, instead other terminal devices may be able only to comply with these imposed requirements.

The inventors realised that currently, the network knows only that the terminal device has to at least comply with the requirements discussed above. There is no way for the network to distinguish between terminal devices that are “average” (achieve better accuracy then required) and “lousy” (achieve only the required accuracy).

Especially relative measurements like relative RSRP measurements are important for decision making. For example, the terminal device compares if a neighbour cell's RSRP is stronger than the RSRP and the comparison may have an effect on handover decisions. The relatively large RSRP inaccuracy may negatively affect these procedures and may lead to poor mobility performance. Potentially, this may result in a beam failure for example when the quality degradation of a serving beam is hidden by the inaccurate estimate, and in turn this may lead to a radio link failure. Further, an undesired handover can occur if the RSRP level of a neighbour cell is overestimated due to poor accuracy, and eventually this may lead to a handover failure or a ping pong (short time of stay).

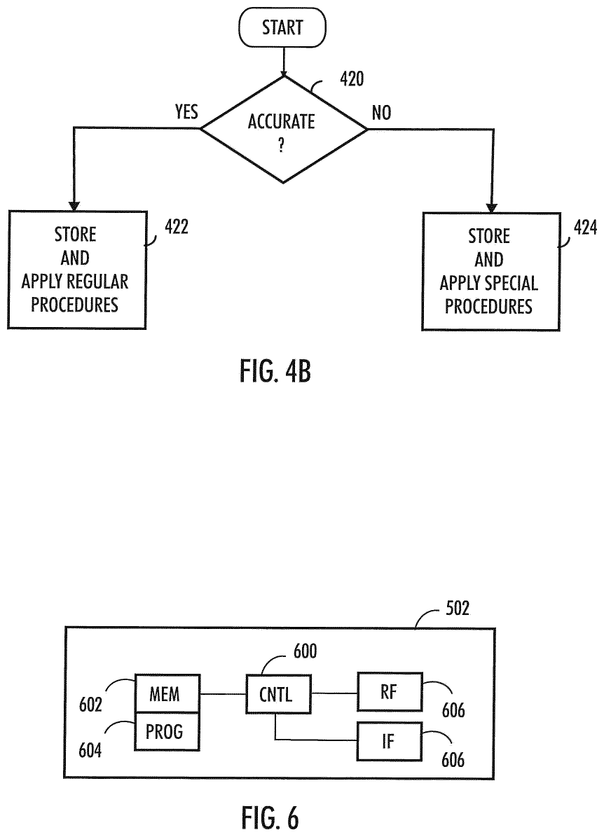

The flowchart of FIG. 4A illustrates an embodiment. The flowchart illustrates an example of the operation of an apparatus. In an embodiment, the apparatus may be a network element, a base station, (e/g)NodeB or a part of a such an apparatus.

In step 400, the apparatus is configured to receive one or more measurement reports from the one or more terminal devices.

In step 402, the apparatus is configured to receive and measure one or more reference signals from the one or more terminal devices.

In step 404, the apparatus is configured to determine the accuracy of the one or more received measurement reports based the one or more measurement reports and the measured one or more reference signals.

In an embodiment, the apparatus is configured to, prior to step 400, configure the terminal device to measure signals transmitted by the apparatus, to report the measurements and to transmit a reference signal.

The flowchart of FIG. 4B illustrates an embodiment. The flowchart illustrates an example of further operation of the apparatus of FIG. 4A.

In step 420, the apparatus is configured to determine, for example following the procedure of FIG. 4A, whether measurements received from a terminal device are accurate or not.

If the measurements received from a terminal device have been determined to be accurate, the determination result is stored, and regular procedures related to the terminal device are applied in step 422.

If the measurements received from a terminal device have been determined to be not accurate, the determination result is stored, and special procedures related to the terminal device are applied in step 424. Examples of the special procedures are described below.

In an embodiment, the apparatus is configured to determine the accuracy of the one or more received measurement reports based on comparison of the measurement reports and the measured one or more reference signals and/or statistical analysis of the measurement reports.

In an embodiment, the apparatus is configured to determine the measurement report to be inaccurate if signal quality indication indicated in a measurement report received from a terminal device changes while the quality indication of one or more reference signals received from the terminal device does not.

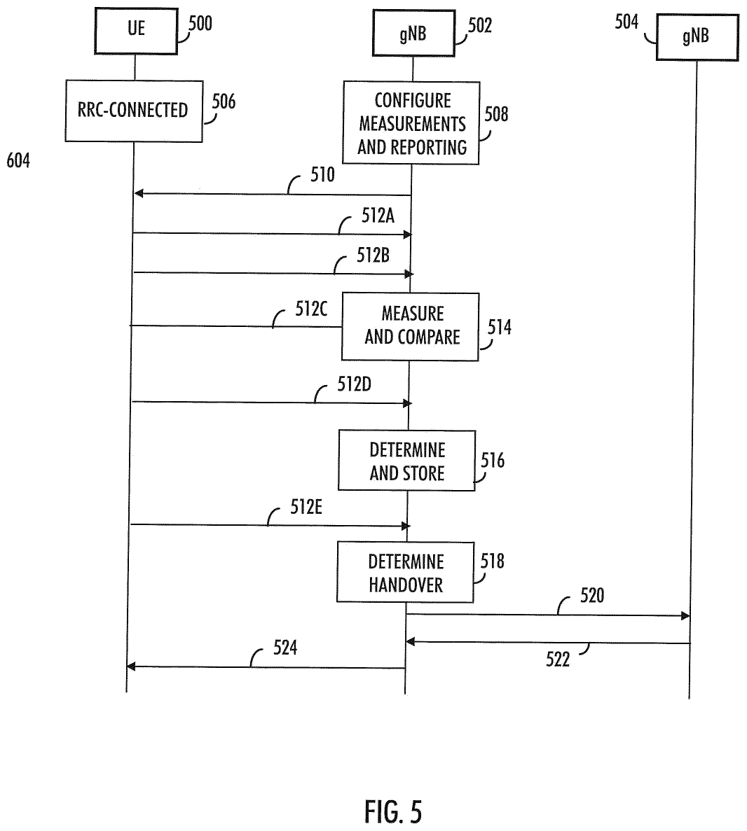

FIG. 5 is a signalling chart illustrating some embodiments. The chart illustrates an example of signalling between a terminal device 500, (e/g)NodeB 502 serving the terminal device and (e/g)NodeB 504 which is a target NodeB in a handover.

The terminal device is served by the (e/g)NodeB 502 and is in RCC CONNECTED state 506.

The serving (e/g)NodeB 502 is configured to determine 508 a measurement and reporting configuration of the terminal device. In an embodiment, the network node configures downlink RSRP measurement and associated reporting for mobility purposes as well as SRS resources according to its regular mobility and RRM policy.

In an embodiment, the RSRP measurement and reporting configuration may be tailored for the measurement validation purposes, for example by configuring periodical reporting and setting “includeBeam-Measurements” to “true”, to acquire also beam-level reporting.

In an embodiment, SRS resources may be tailored for the measurement validation purposes. For example, if the terminal device reports a maxNumberSimultaneousSRS-ResourceTx>1, multiple SRS resources may be configured to the terminal device at one symbol for simultaneous transmission for the network to determine SRS measurements from different terminal device antenna panels.

The (e/g)NodeB 502 transmits measurement and reporting configuration to the terminal device. In an embodiment, the message is a RRC config message including Meas.Config, MeasurementReporting and SRS-Config fields.

The terminal device 500 starts downlink measurements and/or SRS reporting. It transmits reports 512A, 512B, 512C, 512D, 512E at determined intervals.

The (e/g)NodeB 502 receives SRS transmitted by the terminal device and receives downlink measurement results. The (e/g)NodeB starts measuring 514 SRS and starts downlink measurement validation.

In an embodiment, after a given number of results or after a given time frame has elapsed, the (e/g)NodeB may determine 516 the validity of downlink measurements performed by the terminal device.

In an embodiment, each of the one or more terminal devices may be categorized into two or more categories based on the determined accuracy. The determined category of each of the one or more terminal devices may be stored.

In an embodiment, terminal devices are categorized in being “lousy” or “average” in respect to the terminal device capability to measure and report accurate RSRP levels. For example, terminal devices fulfilling minimum requirements of Table 1 may be categorized as “lousy” or “inaccurate” and terminals being capable of better performance may be categorized as “average”. The categorizing may also be performed based on different criteria.

The (e/g)NodeB 502 determines a need for a handover for the terminal device 500. The (e/g)NodeB 502 transmits a handover request 520 to a target (e/g)NodeB 504, the request comprising information on the determined measurement accuracy of the terminal device 500. In an embodiment, the information comprises the category of the terminal device. After the target (e/g)NodeB 504 has acknowledged 522 the request, the (e/g)NodeB 502 transmits a handover command to the terminal device.

The determination of measurement accuracy of a terminal device maybe performed in various ways. In an embodiment, a sequence of downlink RSRP values reported by the terminal device are compared with a sequence of uplink measurements of SRS or other reference signal made at the (e/g)NodeB.

For relative accuracy, if the RSRP level changes while the SRS-based measure does not, this is indicative that RSRP fluctuation is due to relative inaccuracy. In an embodiment, if N consecutive RSRP measurements change more than a given threshold1 while the corresponding N SRS measurements change less than a given threshold2, the RSRP reporting may be determined inaccurate. In an embodiment, the RSRP level is compared against the SRS measures made at different resources (associated to different terminal device transmission antenna panels, for example).

For absolute accuracy: if the RSRP level is deemed too low/high compared to the SRS measure, this is indicative of inaccuracy. In an embodiment, if the average RSRP measurement is above (below) a given threshold3 while the corresponding SRS measurement is below (above) a given threshold4, the absolute RSRP reporting may be determined inaccurate.

In an embodiment, statistical verification methods may be used. For example, sequences of downlink measurement reports of one or more beams of the serving cell may be collected. Sequences of uplink measurements of one or more beams of the serving cell may also be collected. Sequences may be correlated creating statistical indicators, such as correlation coefficients. Before correlation, it may be necessary to average the sequences over time.

In the comparison of SRS measurements made by the (e/g)NodeB and downlink RSRP measurements of the terminal device above, potential uncertainties of the expected uplink-downlink correlation (reciprocity) may be taken onto account.

One uncertainty may be related to power reduction, for example due to maximum permissible exposure, MPE, that may affect uplink transmissions. Based on terminal device reporting MPE events become known to the network side. When an MPE event is known, the (e/g)NodeB is aware that the reciprocity is broken and even if terminal device has high RSRP measurement accuracy, downlink RSRP measurements of the terminal device and uplink SRS measurements of the (e/g)NodeB cannot be compared.

Another uncertainty may be related to fading. Filtering for fading removal may be applied for RSRP at the (e/g)NodeB and/or at terminal device (by setting a longer L3 filter to the terminal device).

A further uncertainty may be that beam correspondence at the (e/g)NodeB and at terminal device may not be perfect. Beam correspondence signalling may be applied utilising either basic requirements (correspondence capability bit-1) and/or tolerant requirements (correspondence capability bit-0). In the latter case, the terminal device may need more SRS to create better beam correspondence.

Based on beam correspondence capability signalling of the terminal device, the network knows that especially the terminal device indicating beam correspondence bit-0 is not likely to perform good autonomous beam correspondence based on downlink reference signals (like SSB or CSI-RS) especially in weak SNR or SINR conditions. Poor beam correspondence of a terminal device in weak SNR or SINR conditions may cause additional uncertainties between downlink and uplink transmission directions and generally is indicative that this terminal device may have a weaker FR2 radio frequency or antenna performance. This knowledge can then be utilized when categorizing the measurement accuracy of the terminal device.

In an embodiment, the categorization of the measurement accuracy of the terminal device may be determined using a combination of additional metrics in addition to solutions described above. The RSRP values may be collected in the cell through Minimization of Driving Test (MDT) statistics and compare the terminal device reported RSRPs to the expected RSRPs in the cell. Further, the accuracy of additional reports such as Channel Quality Indicators (CQIs) may be used.

Network may take various actions based on the determined measurement accuracy of a terminal device. In an embodiment, for terminal devices deemed inaccurate, the network (for example a small cell, where the inaccuracy level is large compared to the radio coverage area) can consider following solutions:
a) The network can avoid configuring measurement reports altogether because ineffective/useless to the terminal device to save signalling and terminal device power. In an embodiment, blind handovers, where measurements are not considered at all) may be used instead for the terminal devices with bad measurement accuracy. At the same time, terminal devices with good accuracy still benefit from measurement-based handover or even enhanced features.
b) In addition or alternatively, multiple cell targets may be prepared for handover upfront by the serving (e/g)NodeB to speed up a potential re-establishment after a radio link failure caused by the lack of a timely handover or handover to a wrong cell (due to inaccurate reporting from the terminal device). The increased overhead by this multi-cell preparation would pay-off for the terminal devices with bad accuracy, whereas it can be avoided for the terminal devices with sufficient accuracy.
c) In addition or alternatively, to minimize the risk of a radio link failure, the network may configure a “lousy” terminal device with dual connectivity for mobility robustness purposes, to benefit from a macro cell as a mobility anchor. the terminal devices with sufficient accuracy may not need the macro anchor which saves signalling and energy. Further, to minimize the risk of a radio link failure, the network may activate uplink SRS based beam management for a “lousy” terminal device, which also indicates bit-0 indication for beam correspondence, to improve chances for successful mobility. It may be noted that a wide and continuous use of uplink SRS resources for beam management may not be effective use of uplink resources, therefore its enabling could be limited to inaccurate terminal devices that would benefit most from it.
d) The network may not allow a terminal device deemed “lousy” or “inaccurate” to use the relaxation of Radio Resource Management (RRM) measurements introduced in Rel-16 for RRC Inactive/Idle terminal devices and that are in low mobility and/or at cell centre, since the triggering criteria are based on RSRP measurements. In this case, the network can send to a terminal device, which is classified as inaccurate, a terminal device-specific indication that “relaxation is not allowed”, for example as part of the RRC release message to RRC Idle or RRC Inactive. A terminal device that received such indication, after moving in RRC Idle/Inactive is not allowed to apply RRM measurements relaxation even if the System Information Broadcast (SIB) indicates that such relaxation is allowed in the cell.
e) In an embodiment, the network may avoid using absolute events altogether for terminal devices with low measurement accuracy and rather use relative events as these are less inaccurate. Configuring or using only relative measurement events, entailing the relative comparison of two measurement values (for example events A3, A6) rather than absolute measurement events, entailing an absolute comparison of a measurement value against an absolute threshold (for example events A1, A2) is beneficial since the achieved relative accuracy can be expected to be higher.

Further, the network may force longer averaging in the terminal device (such as larger filter coefficients, more samples), and/or configure larger time-to-triggers. In addition, RSRP/event reports may be offset (by applying a sort of outer loop link adaption (OLLA) based on the expected RSRP determined from uplink measurements/MDT RSRP).

In general, the network may use different mobility features for terminal devices with low or average measurement accuracy, for example utilising Conditional Handovers for average accuracy terminal devices.

As mentioned in connection with FIG. 5 (message 520), the network may store and transfer the determined measurement accuracy or category of a terminal device across neighbours for example at handover situations to avoid repeating the terminal device categorization multiple times e.g. at different cells and/or when the terminal device establishes a following RRC connection.

It may be assumed that the category of a terminal device can be expected to be semi-static in nature because the terminal device capability of accurate measurements will not change in time and is highly related to terminal device RF implementation imperfections and physical layer algorithms. Thus, it can be made a terminal device property, which can be stored at the network side in order to avoid repeating the assessment for the same terminal device unnecessarily multiple times at the same or a different node.

In an embodiment, after a (e/g)NodeB completes the terminal device classification, the assessment outcome remains valid for a terminal device while the terminal device remains in RRC/CM-CONNECTED mode.

In an embodiment, the (e/g)NodeB may stores the terminal device category related to RSRP accuracy. This can be stored e.g. in the UE context of the terminal device.

In an embodiment, the category can be transferred for example over Xn interface to other neighbouring (e/g)NodeBs (for example at the handover preparation).

In an embodiment, the category information may be defined as a new terminal device accuracy capability information element, IE, and be included in the HANDOVER REQUEST message.
An example of this new IE is shown below.

TABLE 2

| | | | | | |
|---|---|---|---|---|---|
| | | | IE Type | | Assigned |
| IE/Group name | Presence | Range | and ref. | Criticality | criticality |

| | | | | |
|---|---|---|---|---|
| UE accuracy | O | 9.2.3.XX | YES | ignore |
| capability | | | | |

Alternatively, the category can be added as a new IE to the Mobility Information IE.

In an embodiment, the category is associated with a permanent UE identifier. The category could be stored for example at core network at AMF and be provided by the AMF to the RAN after the RRC Setup, for example. The determined information could be signalled to the AMF initially by the NG-RAN that made the terminal device classification via the NG Application Protocol, NGAP, interface. If available, the AMF could provide this information to a NG-RAN e.g. at Initial Context Setup, UE Context modification procedure, Handover preparation procedure, etc. In an embodiment, the identifier can be SUPI (Subscription Permanent Identifier) or a Subscription Concealed Identifier (SUCI), or a NG-5G-S-TMSI (Temporary Mobile Subscriber Identity).

In an embodiment, the network may perform time to time (e.g. after some months) the re-assessment of the terminal device category to check whether the outcome of an earlier assessment is still valid or needs to be updated. For example, the measurement accuracy may have been modified (e.g. improved) by means of a firmware/software upgrade sent by the terminal device manufacturer or mobile operator, which improves the terminal device measurement strategy, and in turn, improves the measurement accuracy that can be achieved by the terminal device. In an embodiment, the stored terminal device category may have a validity period. Whenever the validity period expires, the network performs the re-assessment and overwrites the current terminal device category information.

It may be noted that by storing the category information in the UE context of a terminal device, the network generated information is available in RRC CONNECTED and INACTIVE states.

FIG. 6 illustrates an embodiment. The figure illustrates a simplified example of an apparatus applying embodiments of the invention. In some embodiments, the apparatus may be a network element, base station, (e/g)NodeB, or a part of a such device.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 502 of the example includes a control circuitry 600 configured to control at least part of the operation of the apparatus.

The apparatus may comprise a memory 602 for storing data. Furthermore, the memory may store software 604 executable by the control circuitry 600. The memory may be integrated in the control circuitry.

The apparatus may comprise one or more interface circuitries 606, 608 The interface circuitries are operationally connected to the control circuitry 600. An interface circuitry 606 may be a set of transceivers configured to communicate with terminal devices or UEs of a wireless communication network. The interface circuitry may be connected to an antenna arrangement (not shown). The apparatus may also comprise a connection to a transmitter instead of a transceiver. An interface circuitry 608 may be configured to communicate with other network elements, such as (e/g)NodeBs or core network, in a wired or wireless manner.

In an embodiment, the software 604 may comprise a computer program comprising program code means adapted to cause the control circuitry 600 of the apparatus to realise at least some of the embodiments described above.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, an apparatus comprises means for receiving one or more measurement reports from a terminal device; receiving and measuring one or more reference signals from the terminal device and determining the accuracy of the one or more received measurement reports based on one or more the measurement reports and measured one or more reference signals.

It will be obvious to a person skilled in the art that, as the technology advances, the inventive concept can be implemented in various ways. The invention and its embodiments are not limited to the examples described above but may vary within the scope of the claims.

1. An apparatus in a communication system, comprising
at least one processor;
and at least one memory including computer program code,
the at least one memory and computer program code configured to, with the at least one processor, cause the apparatus to:
receive one or more measurement reports of signal power measurements from a terminal device;
receive and measure one or more reference signals from the terminal device;
determine the accuracy of the one or more received measurement reports based on the one or more measurement reports and the measured one or more reference signals.

2. The apparatus of claim 1, the at least one memory and the computer program code configured to, with the at least one processor, cause the apparatus further to:
categorize the terminal device into two or more categories based on the determined accuracy;
store the category of the terminal device.

3. The apparatus of claim 2, the at least one memory and the computer program code configured to, with the at least one processor, cause the apparatus further to:
during mobility procedure of a terminal device having a category, provide a target network node for the terminal device information related to the category of the terminal device.

4. The apparatus of claim 1, the at least one memory and the computer program code configured to, with the at least one processor, cause the apparatus further to:
configure the terminal device to measure signals transmitted by the apparatus, to report the measurements and to transmit one or more reference signals.

5. The apparatus of claim 1, the at least one memory and the computer program code configured to, with the at least one processor, cause the apparatus further to:
determine the accuracy of the one or more received measurement reports based on comparison of the measurement reports and the measured one or more reference signals and/or statistical analysis of the measurement reports.

6. The apparatus of claim 1, the at least one memory and the computer program code configured to, with the at least one processor, cause the apparatus further to:
if signal quality indication indicated in a measurement report received from a terminal device changes while the quality indication of one or more reference signals received from the terminal device does not, determine the measurement report to be inaccurate.

7. The apparatus of claim 1, the at least one memory and the computer program code configured to, with the at least one processor, cause the apparatus further to:
if difference between the signal strength indicated in a measurement report received from a terminal device and the strength of a reference signal received from the terminal device is greater than a given threshold, determine the measurement report to be inaccurate.

8. The apparatus of claim 1, the at least one memory and the computer program code configured to, with the at least one processor, cause the apparatus further to:
collect sequences of measurement reports related to a given one or more beams utilised by the apparatus;
correlate the sequences with each other to obtain statistical data;
determine the accuracy of the measurement reports received from a terminal device based on the statistical data.

9. The apparatus of claim 1, the at least one memory and the computer program code configured to, with the at least one processor, cause the apparatus further to:
control the connection of the terminal device based on the accuracy of the measurement report of the terminal device.

10. A method in an apparatus in a communication system, comprising:
receiving one or more measurement reports of signal power measurements from a terminal device;
receiving and measuring one or more reference signals from the terminal device;
determining the accuracy of the one or more received measurement reports based on the one or more measurement reports and the measured reference signals.

11. The method of claim 10, further comprising
categorizing each of the terminal device into two or more categories based on the determined accuracy;
store the category of the terminal device.

12. The method of claim 11, further comprising:
during mobility procedure of a terminal device having a category, providing a target network node of the terminal device information related to the category of the terminal device.

13. The method of claim 10, further comprising:
configuring one or more terminal devices to measure signals transmitted by the apparatus, to report the measurements and to transmit one or more reference signals.

14. The method of claim 10, further comprising:
if signal quality indication indicated in a measurement report received from a terminal device changes while the quality indication of a reference signal received from the terminal device does not, the measurement report is determined to be inaccurate.

15. The method of claim 10, further comprising:
determine the accuracy of the one or more received measurement reports based on comparison of the measurement reports and the measured one or more reference signals and/or statistical analysis of the measurement reports.

16. A computer program comprising instructions for causing an apparatus to at least perform:
receive one or more measurement reports of signal power measurements from a terminal device;
receive and measure one or more reference signals from the terminal device;
determine the accuracy of the one or more received measurement reports based on the one or more measurement reports and the measured reference signals.
